(19) United States
(12) Patent Application Publication
(10) Pub. No.: US 2004/0145282 A1
(43) Pub. Date: Jul. 29, 2004

(54) Assembly for on-boat SCUBA tank storage

(76) Inventor: Robert Anthony Bogdan, Pompano Beach, FL (US)

Correspondence Address: EDWARDS & ANGELL, LLP, P.O. BOX 55874, BOSTON, MA, 02205, US

(21) Appl. No.: 10/351,789

(22) Filed: Jan. 27, 2003

(51) Int. Cl. B65G 59/00

(52) U.S. Cl. 312/72

(57) ABSTRACT

An assembly for securing SCUBA gear on a boat without increased use of deck space is provided. A platform is disposed above the deck of a boat. A retainer is disposed above the platform. An opening is disposed within the retainer dimensioned to receive a SCUBA tank therein. The platform may form the upper surface of a cabinet. The cabinet having at least one SCUBA tank supporting member therein. The SCUBA tank supporting member having a radiused surface for securely retaining the SCUBA tank within the cabinet. The support member has a first end and a second end, the first end being higher than the second end.

### BACKGROUND OF THE INVENTION

1. Field of Invention

The present invention is directed to an assembly for storing SCUBA tanks on board a boat, and in particular an apparatus for storing SCUBA tanks at least in part in a manner for easy SCUBA gear assembly and staging.

2. Background

On large commercial dive boats, it is known to store SCUBA tanks in position for assembly and staging utilizing a rack made of a series of U-shaped tank retainers affixed along the side of the boat adjacent a staging bench. During use, the SCUBA diver would sit on the bench adjacent the U-shaped retainer to put on the SCUBA gear, including the tank, during the staging process. An elastic cord may extend over the tank valve to maintain the tank in place within the retainer. Such an arrangement is satisfactory given the large space available on a commercial dive boat. However, the use of such racks, which extend from the boat sidewalls onto the open deck on a smaller, private boat wastes valuable deck real estate.

The fact that huge amounts of space are consumed by dive tank racks is recognized in the art. To overcome this problem, some tank storage systems are made to be removably mounted to structures on the boat so that when SCUBA gear is not required, the entire rack may be removed from the boat. One such system is manufactured by Birdsall Marine and includes a metallic frame which detachably fits into the existing “rocket launcher” of the boat. A plurality of U-shaped retainers for receiving the tank are supported on the frame and extend away from the frame, parallel to the deck of the boat. The U-shaped retainers are provided a height above the deck of the boat as to capture the tank while the tank rests in an upright position on the boat deck. A retaining band is disposed on the frame, between the deck and the U-shaped retainer, to further maintain the tanks in the rack. This rack system suffers from the disadvantage that deck space is only freed up when the rack is not in use, i.e., when the rack is removed. While the rack is in use, valuable deck space is required. Even when no tanks are present in the rack, the footprint of the rack occupies valuable deck space reducing the ability to utilize, and enjoyment derived from, a small pleasure craft. This problem has been solved in part by providing U-shaped tank retainers that fold down when not in use. However, the footprint of the frame and the folded tank retainer extending from the frame still occupy valuable space on the boat deck.

Another solution is to utilize an “egg carton” box which is carried on to the deck. In this way, when the tanks are being used by the divers, the egg carton box can be stored away freeing the deck space. The “egg carton” box has an interior, which resembles the interior of an egg carton so that tanks resting in the egg carton are held in place by the construction of the box. However, when in use, i.e., when the tanks are being stored, the box occupies a significant area of the deck, reducing the enjoyment of the boat.

The egg carton may be put away and stored when not in use or when the divers are in the water. However, because the egg carton rests on the deck, the tanks are low relative to the diver and must be lifted up during staging to be put onto the SCUBA diver. This requires a hard and sometimes unsafe exertion causing some divers to lose their balance and fall. Furthermore, because the egg carton lies on the deck of the boat, it presents a tripping hazard.

Accordingly, an assembly for storing SCUBA tanks which overcomes the shortcomings of the prior art is desired.

### SUMMARY OF THE INVENTION

A SCUBA tank storage assembly, which stores tanks without occupying additional deck area by utilizing existing boat structures, is provided. The SCUBA system assembly includes a platform disposed above the deck of the boat substantially parallel with the deck. A planar retaining member is disposed above the platform. The retaining member has an opening therein sized to receive a SCUBA tank therein.

The platform may include a raised lip or a recessed surface formed in a circle having a diameter substantially equal to the diameter of a SCUBA tank for receiving the SCUBA tank therein; the retaining lip being coaxial with the opening within the retainer.

In a preferred embodiment, a cabinet is disposed on the deck of the boat, the platform forming the roof of the cabinet. The cabinet has shelves therein, each shelf having a support member thereon. The support member includes a radiused surface for receiving a SCUBA tank therein. The Support member is also angled along the surface of the shelf.

The invention accordingly comprises the features of construction, combination of elements and arrangement of parts which will be exemplified in the disclosure herein and the scope of the invention will be indicated in the claims.

### BRIEF DESCRIPTION OF THE DRAWINGS

In the drawing figures, which are not to scale, and which are merely illustrative, and wherein like referenced characters denote similar elements throughout the several views:

FIG. 1 is a perspective view of a SCUBA tank storage assembly constructed in accordance with the invention;

FIG. 2 is a perspective view of a SCUBA tank storage assembly with the tanks therein;

FIG. 3 is a side sectional view of a SCUBA tank storage assembly with tanks stored therein in accordance with the invention; and

FIG. 4 is a front elevational view of a SCUBA tank storage assembly with the cabinet doors removed.

### DETAILED DESCRIPTION OF THE PREFERRED EMBODIMENTS

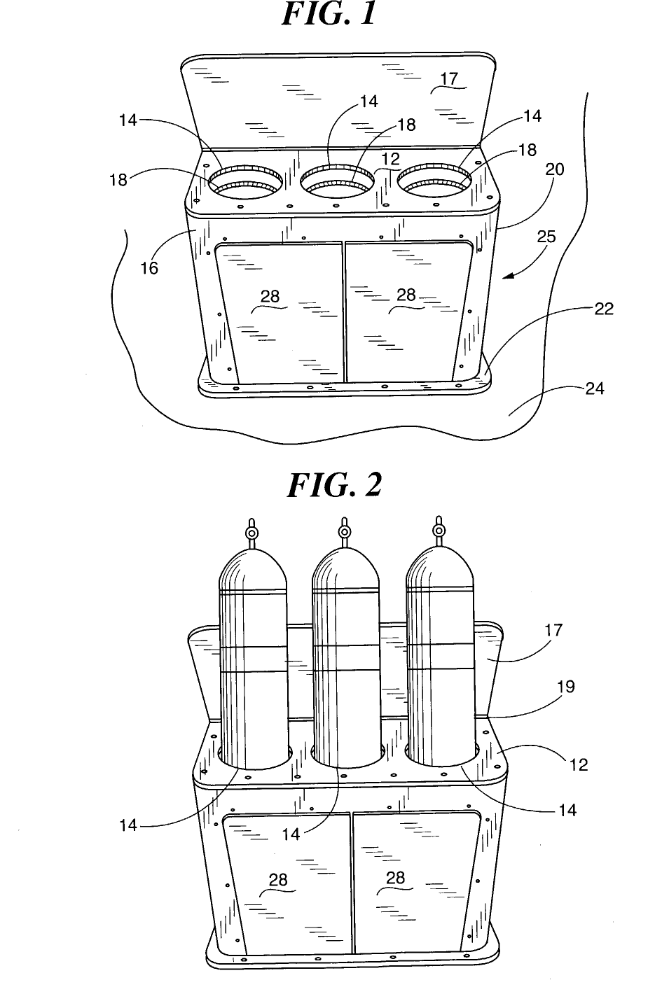

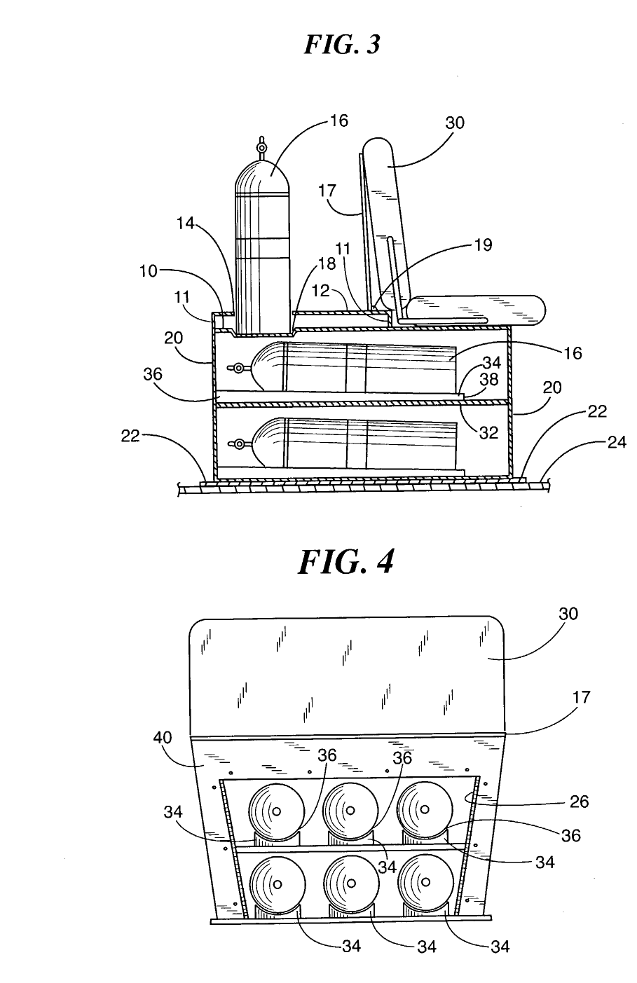

Reference is first made to FIGS. 1, 3 in which an assembly for storing SCUBA tanks on a boat, generally indicated as 50, is depicted. A base 22 is affixed to a deck 24 of a boat. Sidewalls 20 extend from base 22. A platform 20 is supported by sidewalls 20 above deck 24. It should be noted, that sidewalls 20 and platform 10 are preferably formed by an existing structure on the boat so as not to require more deck space in addition to existing boat structure. In a preferred embodiment, platform 20 could be the support for a passenger or captain's seat 30, the bait well (not pictured) of a fishing boat, or the center console cabinetry of a pleasure boat. A planar retainer 12 is disposed above platform 10 and is supported by walls 11. At least one opening 14, to act as a retainer for retaining a SCUBA tank 16 therein, is formed in retainer 12. Opening 14 has a diameter sized slightly larger than the diameter of a SCUBA tank so as to slideably receive a SCUBA tank placed therein.

In a preferred embodiment, a recess 18 forms a receiving ring which is coaxial with opening 14 for receiving the base of a SCUBA tank 16 therein. The inner diameter of the recessed ring 18 is substantially equal to the outer diameter of SCUBA tank 16, so that SCUBA tank 16 comes in contact with and is loosely held in place by ring 18. Ring 18 may be replaced by a circular lip on platform 11 having a diameter substantially equal to the diameter of SCUBA tank 16. In a preferred embodiment, retainer 12 is separated from platform 10 by a distance sufficient to maintain SCUBA tank 16 in place while the boat is moving or during choppy seas, while at the same time allowing SCUBA tank 16 to be easily removed from out of opening 14, i.e. without excessive lifting in an upward direction to clear retainer 12. This distance is between about 3 inches and about ⅓ of the height of SCUBA tank 16 as measured from the base of SCUBA tank 16. The sides of recessed ring 18 may be sloped to facilitate tank 16 being placed in the recesses and removed.

It should be noted, that retainer 12 need only be sized large enough to provide the necessary number of openings 14. As a result, SCUBA storing assembly 50 formed by platform 10 and retainer 12 working in cooperation can be provided in almost any existing boat structure such as a support for a seat 30, as shown in FIG. 3.

During use, SCUBA tanks 16 are placed through opening 14 to be held in place (in a vertical plane relative to platform 11 and deck 24) on platform 11 within retainer 12. The buoyancy control device is affixed to SCUBA tank 16 so that a SCUBA diver merely slips into the buoyancy control device and then stand up so that SCUBA tank 16 clears retainer 12. The SCUBA diver is now prepared to enter the water from an uncluttered deck. It should be noted, that in a preferred embodiment, retainer 12 is just slightly lower than the waist of the SCUBA diver so that a slight bending of the knees of the diver brings the diver in position to secure the buoyancy control device and standing upright clears retainer 12 for easy removal of SCUBA tank 16.

A cover 17 is hingedly affixed to retainer 12 so as to rotate in the direction of arrow A. Cover 17 moves between a first position, which exposes openings 14 as shown in FIGS. 1, 3 and a second position, which covers openings 14 as shown in FIG. 4. In the second position, when retainer 12 is not being used to retain SCUBA tank 16, cover 17 provides a workspace. It should be noted, that cover 17 has a length, which at least extends from a hinge 19 to beyond opening 14. Cover 17 also keeps dirt, water and other extraneous objects from entering opening 14 when a SCUBA tank 16 is not present.

In a preferred embodiment, platform 10 and sidewalls 20 forms a storage cabinet. Sidewalls 20 form a 4-sided container, generally indicated as cabinet 25. Cabinet 25 has an opening 26 therein allowing access to the interior of cabinet 25. Doors 28 are disposed within opening 26 to seal off the interior of cabinet 25 while selectively allowing access to the interior of cabinet 25. Doors 28 are affixed to sidewalls 20 in a manner known in the art. In a preferred embodiment, at least one shelf 32 is provided within cabinet 25. At least one support member 34 is disposed on shelf 32 as well as base 22. Support members 34 are formed with radiused surfaces 36 dimensioned to match the outer circumference of a SCUBA tank to hold a SCUBA tank and prevent the SCUBA tank from rocking and rolling when the boat is in transit or in rough seas. The radiused surface can be a shallow U- or a V-shape as long as it is shaped to engage a sufficient part of SCUBA tank 16 to secure it in place within cabinet 25.

Furthermore, in a preferred embodiment, support member 34 has a first end 36, which is adjacent opening 26 and a second end 38 away from opening 26. First end 36 is higher than second end 38. In this way, SCUBA tank 16 is held on an angle, sloping away from opening 26, which further prevents SCUBA tank 16 from sliding out through doors 27 in rough water or in transit.

It should be noted that it is possible to form shelves 32 or base 22 as supporting member 34, i.e. the shelf itself will have a plurality of radiused surfaces therein, and may be angled away from the front of cabinet 26.

It should also be noted that the assembly may be built as a custom unit as discussed above in which other boat structures are built thereon, such as a captain or passenger seat 30 and work surface 17. However, it should be noted that the salient features of the invention may be retrofitted to existing boat structures further performing one of the desired objectives of the invention, which is to provide SCUBA gear securing structures without requiring the use of additional boat deck space. For example, the structure of platform 11, retainer 12 and even cover 17 can be dropped into the existing bait well of a pleasure fishing boat so that a fishing boat can be temporarily or permanently converted to a dive boat. In this way, assembly 50 can be releasably affixed to the boat.

While there have been shown and described and pointed out novel features of the present invention, as applied to preferred embodiments thereof, it will be understood that various omissions and substitutions and changes in form and details of the disclosed invention may be made by those skilled in the art without departing from the spirit of the invention. It is the intention, therefore, to be limited only as indicated by the scope of the claims appended hereto.

It is also to be understood that the following claims are intended to cover all the generic and specific features of the invention herein described and all statements of the scope of invention which, as a matter of language, might be said to fall therebetween.

What is claimed is:

1. An assembly for securing a SCUBA tank on a boat comprising:
a platform disposed above a boat deck;
a planar retainer disposed above said platform; and
at least one opening provided in said retainer, said opening having a circumference dimensioned to receive a SCUBA tank therein.

2. The assembly of claim 1, wherein said platform is a surface of an existing boat structure.

3. The assembly of claim 1, further comprising a lip disposed on said platform, said lip being formed substantially as a circle and having a diameter sized to receive and retain a SCUBA tank therein when said SCUBA tank is retained within said opening.

4. The assembly of claim 1, further comprising a cover rotatably affixed to said retainer, said cover being rotatable between a first position in which to provide access to said opening and a second position in which said cover covers said opening.

5. The assembly of claim 1, further comprising a seat.

6. The assembly of claim 5, wherein said seat is disposed on said platform.

7. The assembly of claim 1, wherein said platform forms a roof of a cabinet.

8. The assembly of claim 7, further comprising at least one support member disposed in said cabinet, said support member having a radiused surface.

9. The assembly of claim 8, wherein said radiused surface is substantially U-shaped.

10. The assembly of claim 8, wherein the radiused surface is V-shaped.

11. The assembly of claim 8, wherein said support member has a first end and a second end, the first end being higher than said second end.

12. The assembly of claim 8, further comprising at least one shelf disposed within said cabinet.

13. The assembly of claim 12, wherein said at least one support member is disposed on said at least one shelf.

14. The assembly of claim 12, wherein said shelf is the support member, said shelf having a region therein having a radiused surface.

15. The assembly of claim 14, wherein said shelf has a first end and a second end, the first end, the first end of said shelf being disposed within said cabinet higher than the second end of said shelf.

16. The assembly of claim 1, wherein said platform and said retainer are detachably attached to an existing structure of said boat.

17. A cabinet for storing SCUBA tanks therein on the deck of a boat comprising:
sidewalls extending substantially perpendicular from the deck, the sidewalls forming an interior;
at least a first support member disposed within said interior, substantially parallel to said deck, said support member having a radiused surface thereon for receiving a SCUBA tank in an orientation substantially parallel to the deck.

18. The cabinet of claim 17, further comprising an opening in at least one sidewall of said cabinet, and at least one door disposed in said opening for providing access to the interior of said cabinet.

19. The cabinet of claim 17, further comprising at least one shelf, at least one support member being disposed on said shelf.

20. The cabinet of claim 17, wherein said support member has a first end and a second end, the first end being higher than the second end.

21. The cabinet of claim 20, wherein said first end is adjacent to said opening.

22. The cabinet of claim 17, further comprising at least one shelf therein, said shelf forming the support member, said shelf having a region with said radiused surface therein.

23. The cabinet of claim 22, wherein said shelf has a first end and a second end, the first end of said shelf being disposed within said cabinet higher than the second end of said shelf.

24. The cabinet of claim 17, further comprising a roof, said roof forming a platform; a planar retainer disposed above said platform; and at least one opening provided in said retainer, said opening having a circumference dimensioned to receive a SCUBA tank therein.
